(19) United States
(12) Patent Application Publication
(10) Pub. No.: US 2024/0176994 A1
(43) Pub. Date: May 30, 2024

(54) EFFICIENT NEURAL CAUSAL DISCOVERY

(71) Applicant: QUALCOMM TECHNOLOGIES, INC., San Diego, CA (US)

(72) Inventors: Phillip LIPPE, Amsterdam (NL); Taco Sebastiaan COHEN, Amsterdam (NL); Efstratios GAVVES, Amsterdam (NL)

(21) Appl. No.: 18/551,844

(22) PCT Filed: Jul. 26, 2021
(86) PCT No.: PCT/US2021/043220

§ 371 Date: Sep. 21, 2023

(30) Foreign Application Priority Data
May 28, 2021 (GR) 20210100356

(51) Int. Cl. G06N 3/0464; G06N 3/09

(52) U.S. Cl. CPC G06N 3/0464; G06N 3/09

(57) ABSTRACT

A method for generating a causal graph includes receiving a data set including observation data and intervention data corresponding to multiple variables. A probability distribution is determined for each variable based on the observation data. A likelihood of including each edge in the graph is computed based on the probability distribution and the intervention data. Each edge is a causal connection between variables of the multiple variables. The graph is generated based on the likelihood of including each edge. The graph may be updated by iteratively repeating the determination of the probability distribution and the computing of the likelihood of including each edge.

### CROSS-REFERENCE TO RELATED APPLICATION

The present application claims priority to Greece Patent Application No. 20210100356, filed on May 28, 2021, and titled “EFFICIENT NEURAL CAUSAL DISCOVERY,” the disclosure of which is expressly incorporated by reference in its entirety.

### FIELD OF INVENTION

Aspects of the present disclosure generally relate to generating causal graphs using artificial neural networks.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, pattern recognition, speech recognition, autonomous driving, and other classification tasks.

Deep neural networks have greatly improved streaming data (e.g., image, video, inertial measurement unit (IMU) data, radar, and WiFi) classification performance. It is desirable to incorporate such networks with Internet of things (IoT) devices, smartphones, or other low power devices that stream data. Unfortunately, the extensive resources consumed for classification due to the amount of computation involved makes it challenging to utilize deep neural networks on real-time, energy-sensitive applications.

### SUMMARY

The present disclosure is set forth in the independent claims, respectively. Some aspects of the disclosure are described in the dependent claims.

In an aspect of the present disclosure, a method is provided. The method includes receiving a data set including observation data and intervention data corresponding to multiple variables. The method also includes determining a probability distribution for each variable of the multiple variables based on the observation data. Additionally, the method includes applying the probability distribution to computing a likelihood of including each edge in a graph based on the probability distribution and the intervention data. Each edge connects variables of the multiple variables. Further, the method includes generating the graph based on the likelihood of including each edge.

In an aspect of the present disclosure, an apparatus is provided. The apparatus includes a memory and one or more processors coupled to the memory. The processor(s) are configured to receive a data set including observation data and intervention data corresponding to multiple variables. The processor(s) are also configured to determine a probability distribution for each variable of the multiple variables based on the observation data. In addition, the processor(s) are configured to compute a likelihood of including each edge in a graph based on the probability distribution and the intervention data. Each edge connects variables of the multiple variables. Further, the processor(s) are configured to generate the graph based on the likelihood of including each edge.

In an aspect of the present disclosure, an apparatus is provided. The apparatus includes means for receiving a data set including observation data and intervention data corresponding to multiple variables. The apparatus also includes means for determining a probability distribution for each variable of the multiple variables based on the observation data. Additionally, the apparatus includes means for computing a likelihood of including each edge in a graph based on the probability distribution and the intervention data. Each edge connects variables of the multiple variables. Further, the apparatus includes means for generating the graph based on the likelihood of including each edge.

In an aspect of the present disclosure, a non-transitory computer readable medium is provided. The computer readable medium has encoded thereon program code. The program code is executed by a processor and includes code to receive a data set including observation data and intervention data corresponding to multiple variables. The program code also includes code to determine a probability distribution for each variable of the multiple variables based on the observation data. Additionally, the program code includes code to compute a likelihood of including each edge in a graph based on the probability distribution and the intervention data. Each edge connects variables of the multiple variables. Furthermore, the program code includes code to generatE the graph based on the likelihood of including each edge.

computing a likelihood of including each edge in a graph based on the probability distribution and the intervention data, each edge connecting variables of the plurality of variables

[symbol]

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions, in accordance with aspects of the present disclosure.

FIG. 5 is a diagram illustrating an example process for causal discovery, in accordance with aspects of the present disclosure.

FIG. 6 is a flow diagram illustrating a method for generating a causal graph, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Uncovering and understanding causal mechanisms is an important problem not only in machine learning but also in other scientific disciplines including computational biology, epidemiology, and economics, for example. One representation of causal mechanisms are causal graphical models (CGM). A causal graph is a probabilistic graphical model used to represent or model the relationship between data and a particular result (e.g., a medical condition) or state. Causal graphical models represent a joint probability distribution as a directed acyclic graph (DAG) where each graph node may correspond to one random variable. The joint probability distribution is factorized according to the edges in the graph, which at the same time constitute direct causal relationships between pairs of node variables.

Given samples from the joint distribution, causal structure learning involves the task of recovering the underlying DAG. Using observational data alone, the underlying DAG may only be identifiable up to graphs that encode the same set of conditional independence relations (e.g., Markov equivalence class). As such, it is often very difficult to determine the direction of causal edges.

Various approaches have been proposed to tackle causal discovery from observational and interventional data, and can most commonly be categorized into constraint-based and score-based approaches. Constraint-based methods find the causal structure based on conditional independence relationships in the data. Score-based methods, on the other hand, search through the space of all possible causal structures with the goal of optimizing a specified score function. This score function is usually a combination of how well the graph structure fits the data, as well as regularizers for encouraging sparsity and enforcing acyclic graphs. Acyclic graphs are graphs with directed edges where following those directions will never form a closed loop. To allow gradient-based methods, other works have investigated the formulation of score-based causal discovery as a continuous optimization problem.

Score-based approaches with continuous optimization commonly suffer from three major challenges. One recurring issue of conventional score-based methods is how to limit the search space of causal structures to acyclic graphs. A causal graph describing the causal relations among variables has to be acyclic to represent a valid probability distribution, meaning it is a directed acyclic graph (DAG). A DAG is a graph in which all paths are acyclic. In other words, a DAG is a graph that flows in one direction, such that no node or variable is a child of itself.

Conventional score-based methods incorporate a regularizer in the score function that measures the degree to which a graph is a DAG and is minimized alongside with the negative log-likelihood of the data. Nevertheless, conventional causal discovery methods are sensitive to the weight assigned to the regularizer, and choosing the right weight depends on prior knowledge of the data likelihood.

Additionally, to trust the output of a causal discovery, in some aspects, a theoretical guarantee or confidence metric may indicate that the methods of the present disclosure find the true causal graph (e.g., ground truth) under the limit of infinite data and other assumptions such as faithfulness (e.g., causal relations in the ground truth graph can be found in the data). Many of the conventional techniques for score-based causal discovery with continuous optimization do not provide such guarantees.

Moreover, aspects of the present disclosure provide approaches that are efficient and scalable. Conventional approaches often only work for small graphs with fewer than twenty nodes, while in a real-world scenario, causal graphs may have one thousand nodes or more. This is not only challenging in terms of computational power (e.g., memory and hardware speed), but also the method has to be efficient in its usage to be able to learn in reasonable times. Specifically, for continuous optimization approaches in causality, low-variance gradients/gradient estimators may aid in learning large graphs.

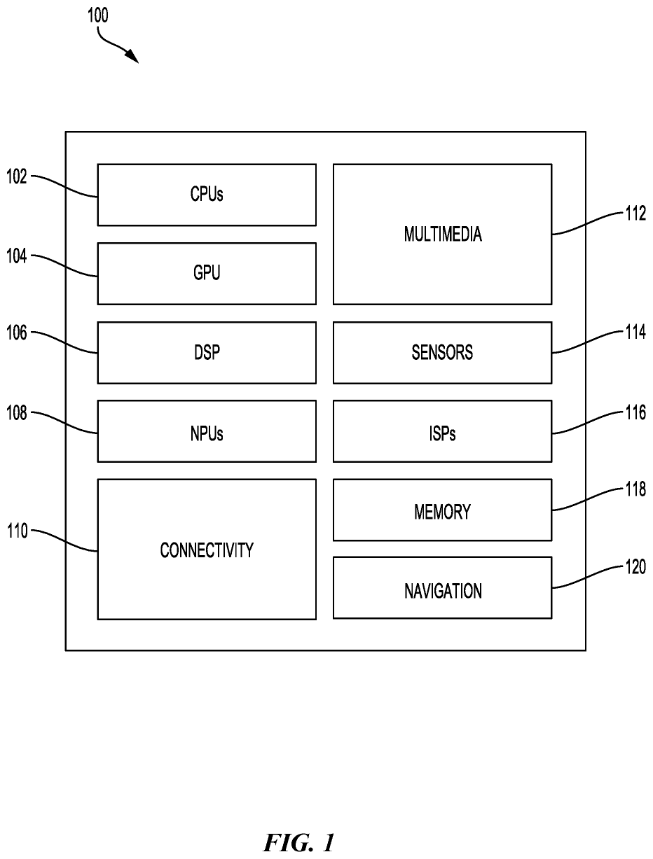

FIG. 1 illustrates an example implementation of a system-on-a-chip (SOC) 100, which may include a central processing unit (CPU) 102 or a multi-core CPU configured for causal graph discovery. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive a data set including observation data and intervention data corresponding to multiple variables. The general-purpose processor 102 may also include code to determine a probability distribution for each variable of the multiple variables based on the observation data. In addition, the general-purpose processor 102 may include code to compute a likelihood of including each edge in a graph based on the probability distribution and the intervention data. Each edge connects variables of the multiple variables. The general-purpose processor 102 may further include code to generate the graph based on the likelihood of including each edge. The general-purpose processor 102 may also include code to update the graph by iteratively repeating the determining the probability distribution and computing the likelihood of including each edge.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

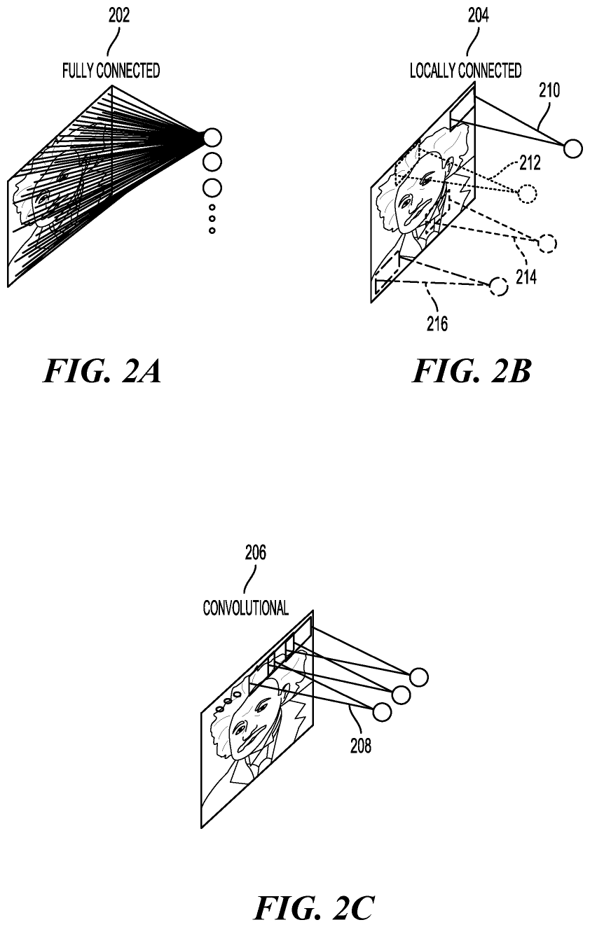

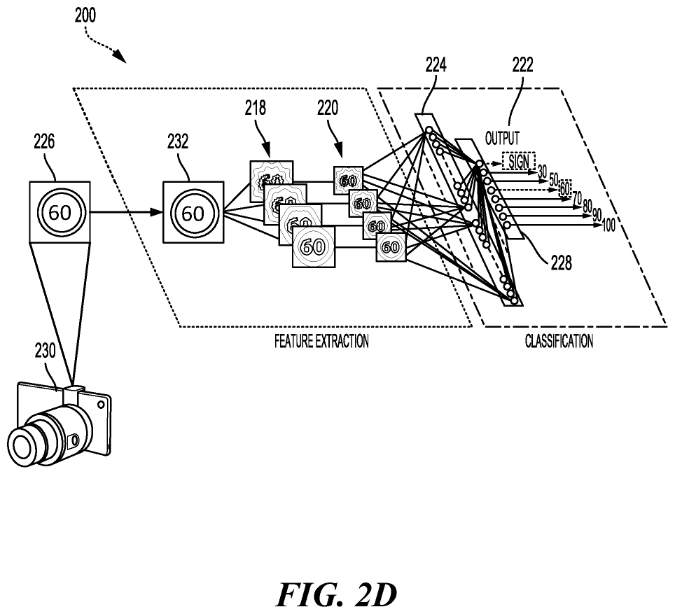

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

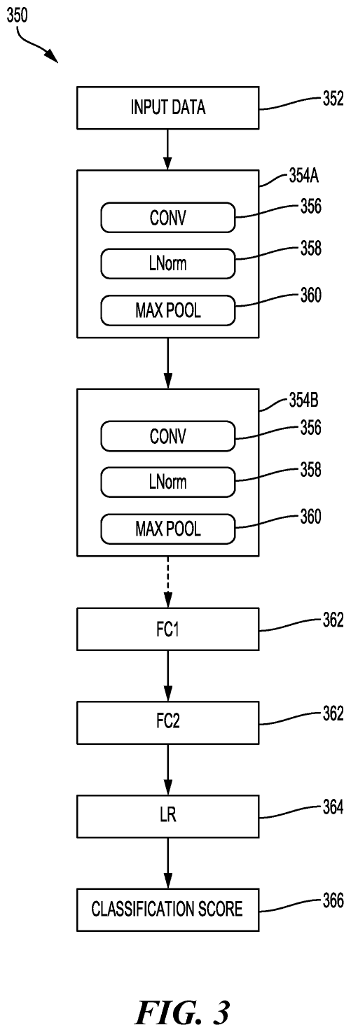

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

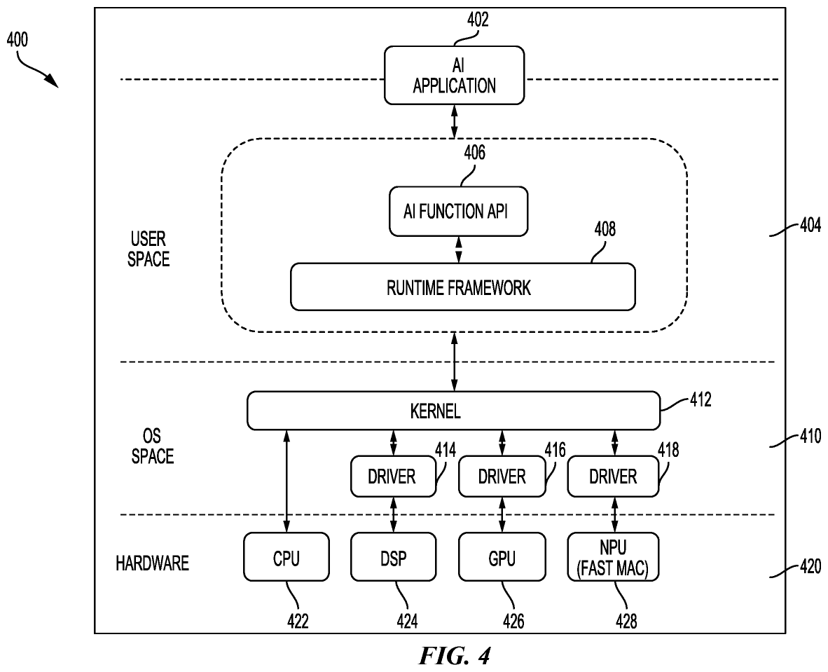

FIG. 4 is a block diagram illustrating an exemplary software architecture 400 that may modularize artificial intelligence (AI) functions. Using the architecture, applications may be designed that may cause various processing blocks of an SOC 420 (for example a CPU 422, a DSP 424, a GPU 426 and/or an NPU 428) to support adaptive rounding as disclosed for post-training quantization for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space 410, such as a Kernel 412, running on the SOC 420. In some examples, the Kernel 412 may be a Linux Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428.

Aspects of the present disclosure are directed to generating causal graphs using an artificial neural network. A score-based causal discovery method learns the causal graph using neural networks and orientation parameters for the causal directions in the graph. For each pair of causal variables Xᵢ and Xⱼ, a probability distribution is modeled over possible graphs by considering the probability of each edge/causal relation as independent of each other. In some aspects, the probabilities may be optimized such that all edges in the ground truth graph converge to one and with the correct direction, and all others to zero. Accordingly, the probabilities may be learned in an iterative manner.

As described, a causal graphical model (CGM) may be defined by a distribution [symbol] over a set of random variables X={X₁, . . . , X_{N}} and a directed acyclic graph (DAG) G=(V, E). In the causal graph, each node i∈V corresponds to the random variable Xᵢ and an edge (i, j)∈E represents a direct causal relation from variable Xᵢ to Xⱼ: Xᵢ→Xⱼ. The DAG G and a joint distribution [symbol] are said to be faithful to each other if all and only the conditional independences true in [symbol] are entailed by G. The joint distribution of all variables may be expressed based on the graph [symbol] (X)=Πᵢ₌₁^{N} [symbol] (Xᵢ|pa(Xᵢ)), where pa(Xᵢ) is the set of parents of the node i in G.

The faithfulness conditions are for recovery of the DAG G from the joint distribution [symbol] . Discovering G from samples of the joint distribution [symbol] is referred to as structure learning or causal discovery, which is a fundamental problem in causality.

Aspects of the present disclosure focus on causal structure learning from observational and interventional data. An intervention on a variable Xi describes the local replacement of its conditional distribution pᵢ(Xᵢ|pa(Xᵢ)) by a new distribution \tilde{p}(Xᵢ|pa(Xᵢ)). Xi may be referred to as the target of the intervention. Samples obtained from [symbol] without any interventions is called observational data.

As multiple DAGs may encode the same set of conditional independences, observational data alone may be insufficient to provide a unique recovery. In accordance with aspects of the present disclosure, orientation parameters may enforce only one direction of an edge to be included in the causal structure. As such, a DAG regularizer may be eliminated from the objective. Additionally, in some aspects, low-variance gradient estimators for both parameters may improve efficiency and scalability. Moreover, the present disclosure converges to a true causal graph. Furthermore, latent cofounders may be identified to enable learning a causal graph in which all variables are not observed.

To learn a causal graph from observational and interventional data, aspects of the present disclosure may model a probability for each possible directed edge between pairs of variables. The probabilities may be improved and, in some aspects optimized, such that all edges in the ground truth graph converge to one and with the correct direction, and all others to zero. Accordingly, aspects of the present disclosure may exploit independent causal mechanisms. That is, in some aspect the causal discovery may search for a graph which generalizes from observational to interventional data. In the ground-truth causal graph, conditional distributions for all variables stay invariant under an intervention except the intervened ones. However, this does not hold for graphs that model the same distribution but with a flipped (e.g., incorrect orientation), missing, or additional edge. Thus, aspects of the present disclosure may alternate between two learning stages of distribution fitting and graph fitting.

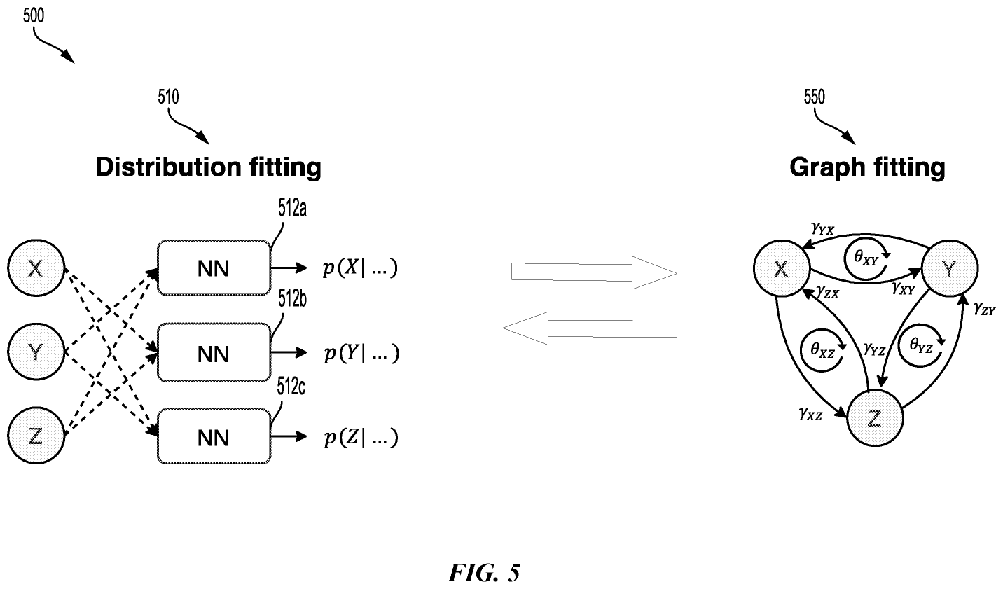

FIG. 5 is a diagram illustrating an example process 500 for causal discovery, in accordance with aspects of the present disclosure. As discussed, the edge probabilities may be learned by alternating distribution fitting 510 and graph fitting 550. In distribution fitting 510, a neural network (NN) (e.g., 512a, 512b, and 512c) may be trained for each variable (e.g., X, Y, Z) to model its observational data distribution. That is, each of the neural networks may be trained for a different causal variable and may be conditioned on a different set of variables. For instance, the neural network 512c may be conditioned on X, Y, or a combination of X and Y.

To allow flexible conditioning on other variables, a dropout may be applied to the input variables with the probability of the corresponding edges. Dropout may refer to an instance in which one or more of the variables that may have a causal relationship with a variable for which a probability distribution is being computed, may not be supplied as input in training the respective networks (e.g., edge probability distributions). In one example, during training, an input variable Xⱼ may be randomly masked by setting it to zero. This may be done with the probability (according to the current state of the model) of its corresponding edge Xⱼ→Xᵢ. Accordingly, during training, an input mask may be sampled with binary values (0 or 1) for every training example. Based on this mask, the input Xⱼ to the neural network that models p(Xᵢ| . . . ) is set to zero if the mask element (i,j) is zero. In some aspects, the mask elements may be sampled from a Bernoulli distribution where the probability of sampling a 1 is the probability of the edge Xⱼ→Xᵢ. The dropout may be applied occasionally or in some cases randomly. In one example, in training the neural network 512a, the Y input may be randomly dropped (e.g., not supplied) in determining the probability distribution.

In the graph fitting stage 550, the learned networks and interventional data are used to compare multiple graphs sampled from the edge probabilities, and to determine gradient updates of those probabilities. As shown in the graph fitting stage, each edge connecting the variables X, Y, and Z may be evaluated to assess the causal relationship between the respective variables. To aid the evaluation, two parameters may be considered for each edge. That is, for parameterizing the edge probabilities, two sets of parameters may be used: γ models the existence of edges in a graph, and θ models the orientation of the edges. The likelihood of an edge between Xᵢ and Xⱼ is determined by p(Xᵢ→Xⱼ)=σ(γᵢⱼ)·σ(θᵢⱼ), where σ is the sigmoid function and θᵢⱼ=−θⱼᵢ (e.g., the probability of the two orientations may sum to one).

The benefit of separating the edge probabilities into γ and θ is that while the existence of an edge can be learned from intervening on any variable in the graph, the orientation can only be reliably detected from data for which an intervention is performed on its adjacent nodes (e.g., Xᵢ or Xⱼ for learning θᵢⱼ). In doing so, increased control over the gradient updates may be achieved. Despite having one variable for the orientation, γᵢⱼ and γⱼᵢ are learned as two independent parameters. This is because based on interventional data, the existence of an edge may be beneficial in one direction, but may not be beneficial in the opposite direction as well. Hence, a joint parameter for both directions may lead to difficulties during learning.

After training, a graph prediction may be obtained by selecting the edges for which σ(γᵢⱼ) and σ(θᵢⱼ) is greater than 0.5. Thereby, the orientation parameters prevent any two-variable loops because in only one direction, σ(θᵢⱼ) can be greater than 0.5. In other words, σ(θᵢⱼ) and σ(θⱼᵢ) cannot both be greater than 0.5 at the same time. While the orientation parameters may not assure the absence of loops with more variables at any stage of the training, in some aspects, the parameters may converge to the correct, acyclic graph.

In some aspects, the graph parameters γ and θ may be improved (and in some cases optimized) by applying an objective where the global minimum is at the correct causal graph. For instance, this may be achieved by minimizing the log-likelihood estimate of all variables learned from observational data and evaluated on interventional data while keeping the number of edges minimal. Formally, this objective can be written as:

$$= {}_{{\hat{I}}_{∼ pl} ( I )} {}_{{\hat{p}}_{\hat{i}} ( x )} {}_{γ , {θ}^{( C )}} [ {\sum }_{i = 1}^{N} {}_{C} ( {X}_{i} ) ] + {}_{sparse} {\sum }_{i = 1}^{N} {\sum }_{j = 1}^{N} σ ( {γ}_{ij} ) σ ( {θ}_{ij} ) , \qquad ( 1 )$$

where [symbol] corresponds to the expectation (or expected value), p_{I}(I) is the distribution over interventions that are performed, \tilde{p}_{Î}(X) is the joint distribution of all variables under the intervention Î. In other words, these two distributions represent our interventional data distribution. The distribution over adjacency matrices C under γ, θ is denoted by p_{γ,θ}(C) with Cᵢⱼ˜Ber(σ(γᵢⱼ)σ(θᵢⱼ)), and [symbol] _{C}(Xᵢ) is the negative log-likelihood of variable Xᵢ conditioned on the parents pa(Xᵢ) according to the adjacency matrices C. The log-likelihood may be estimated using the neural networks of the distribution fitting stage. The second term of Equation 1 represents an [symbol] -regularizer on the edge probabilities with the hyperparameter [symbol] ₛₚₐᵣₛₑ as a regularization weight. While the first term may be minimized only by graphs that have the same edges as the ground truth graph, the regularizer may remove redundant edges from the graph. In contrast to conventional score-based methods, a DAG regularizer is not used to penalize cyclic graphs. Because the orientation parameters already prevent two-variable loops, other graphs with loops cannot achieve a lower score than the ground truth graph.

To update γ and θ based on the objective in Equation 1, the gradients for both γ and θ may be determined. For the parameter γᵢⱼ, a gradient may be expressed as:

$$\frac{\partial }{{\partial }_{{γ}_{ij}}} = {σ}^{′} ( {γ}_{ij} ) \cdot σ ( {θ}_{ij} ) \cdot {}_{X , {C}_{- ij}} [ {{X}_{i} \to {x}_{j}}_{} ( {X}_{j} ) - ( {X}_{j} ) + {}_{sparse} ] , \qquad ( 2 )$$

where [symbol] _{X,C}_{_{−ij}} summarizes the previous three expectations up to the edge Xᵢ→Xⱼ and excluding interventions on Xⱼ as the intervened graph does not have any input connections to Xⱼ. Further, [symbol] _{X}_{ᵢ}_{→X}_{ⱼ}(Xⱼ) denotes the (expected) negative log-likelihood for Xⱼ under adjacency matrices for an edge from Xᵢ to Xⱼ (e.g., Cᵢⱼ=1). The gradient as written may be explained: if the log-likelihood estimate of Xⱼ is improved with the edge Xᵢ→Xⱼ by more than [symbol] ₛₚₐᵣₛₑ, then γᵢⱼ may be increased and otherwise γᵢⱼ may be decreased.

The orientation parameters θ can be similarly derived as γ, with the difference that only the gradients for θᵢⱼ are taken when the intervention is performed on Xᵢ or Xⱼ. Accordingly the gradient may be expressed as:

$$\frac{\partial }{{\partial }_{γ ij}} = {σ}^{′} ( {θ}_{ij} ) ( p ( {I}_{{X}_{i} )} \cdot σ ( {γ}_{ij} ) \cdot {}_{{I}_{{X}_{i}} X , {C}_{- ij}} [ {}_{{X}_{i} \to {X}_{j}} ( {X}_{j} ) - ( {X}_{j} ) ] - p ( {I}_{{X}_{j}} ) \cdot σ ( {γ}_{ji} ) \cdot {}_{{I}_{{X}_{j}} X , {C}_{- ij}} [ {}_{{X}_{j} \to {X}_{i}} ( {X}_{i} ) - ( {X}_{i} ) ] ) , \qquad ( 3 )$$

where p(I_{X}_{ᵢ}) represents the probability of taking an intervention on Xᵢ (usually uniform across variables). The orientation parameter θᵢⱼ may be increased when the edge Xᵢ→Xⱼ is beneficial for estimating the log-likelihood of Xⱼ under interventions on Xᵢ, and vice versa. Note that there will be no case where the edge is beneficial in both directions as this would indicate a cycle in the ground truth graph. For independent nodes, the expectation of the gradients is zero. In some aspects, the gradients of θᵢⱼ are not considered with respect to the edge regularizer. This is because the orientation parameter models only the direction of the edge, not whether it exists. Additional assumptions may be used in such case for guaranteeing the discovery of the true graph upon convergence.

Based on Equation 2 and 3, a tractable unbiased gradient estimator may be obtained by using Monte Carlo sampling, for example. Monte Carlo sampling is a class of techniques for randomly sampling a probability distribution. Samples may be shared across variables making training efficient. Specifically, an intervention, a corresponding data batch, and K graphs may be sampled from p_{γ,θ}(C) (e.g., between 20 and 100 graphs). The log-likelihoods of all variables for these graphs on the batch may be evaluated using the interventional data. The log-likelihoods may estimate [symbol] _{X}_{ⱼ}_{→X}_{ᵢ}(Xᵢ) and [symbol] (Xᵢ) for all pairs of variables Xᵢ and Xⱼ by simply averaging the results for the two cases separately. Those likelihood estimates are used to determine the gradients for γ and θ.

In order to improve confidence in the output (e.g., a causal graph), an analysis may be conducted under which assumptions may guarantee or improve a confidence metric that estimated graph convergences to the correct causal graph given sufficient time and data. As gradient-based optimization is performed, this may be equivalent to showing when the objective does not contain any local minima to hinder convergence.

Overall, the convergence of causal graph discovery may be structured as having three optimization stages, where the later stages build upon the earlier ones. In practice, all of these stages may be conducted concurrently or in parallel to enable faster convergence. The first optimization stage is based on the gradients of the orientation parameters θ pointing, in expectation, toward the correct direction, independent of the specific values of θ and γ. This is the case if the following condition holds: for all edges Xᵢ→Xⱼ in the true causal graph, there exists a set of parents \hat{p}a(Xⱼ) for Xⱼ with probability greater than zero for which:

$${}_{{I}_{{X}_{i}} X} [ log p ( {X}_{j} \vert \hat{p} a ( {X}_{j} ) ) - log p ( {X}_{j} ) \vert \hat{p} a ( {X}_{j} ) , ( {X}_{i} ) ) ] < 0 \qquad ( 4 )$$

The intuition behind this assumption is that the prediction of Xⱼ conditioned on Xᵢ cannot be worse than without Xᵢ if there exists a causal relation in the ground truth graph, and hence the worst case is a gradient of zero in expectation. If for any sampled graph and interventional data point the likelihood estimate improves, the gradient is negative (e.g., increase θᵢⱼ). Similarly, the gradient for the opposite direction is positive. This condition naturally follows from the faithfulness assumption of the graph if all possible values of X have a non-zero probability under the intervention(s) I_{X}_{ᵢ}. Moreover, using a similar derivation, the orientation parameters are also correctly learned for ancestor-descendant pairs without a direct edge.

Using the fact that the orientation parameters will converge for parent-child and ancestor-descendant pairs, the conditions under which σ(γᵢⱼ) converges to one if Xᵢ→Xⱼ is an edge in the true causal graph may be considered. In doing so, a comparison between the log-likelihood improvements and the sparsity regularizer may be made, because setting the regularizer to [symbol] ₛₚₐᵣₛₑ=inf (infima or upper bound of an ordered set) may lead to an empty graph being optimal, thus not converging to the intended graph. Namely, an edge Xᵢ→Xⱼ of the ground truth graph can be recovered for which:

$${min}_{\hat{p} a \underline{⊂} gpa ( {X}_{j} )} {}_{{\hat{I}}_{∼ p I} ( I )} {}_{{\hat{p}}_{\hat{i}} ( x )} [ log p ( {X}_{j} \vert \hat{p} a ( {X}_{j} ) ) - log p ( {X}_{j} \vert \hat{p} a ) ] > {}_{sparse} \qquad ( 5 )$$

where gpa(Xⱼ) is the set of nodes which, according to the ground truth graph, could have an edge to Xᵢ without introducing a cycle. Children and descendants nodes in gpa(Xⱼ) may be excluded because the likelihood of the orientation for these edges converges to zero. The assumption can also be restricted to interventional data on Xᵢ only if such is solely used to train γᵢⱼ. However, in practice, less interventional data is available increasing the chances of inaccurate estimates, and sparser updates lead to slower training.

From Equation 5, it may be understood that the lower [symbol] ₛₚₐᵣₛₑ is set, the more edges that it may discover. However, very low values of [symbol] ₛₚₐᵣₛₑ may result in increased training times as it slows down the third optimization stage. The third stage is after all edges in the ground truth graph have converged, all other edges will have a gradient towards decreasing γij as long as [symbol] ₛₚₐᵣₛₑ>0 because all other pairs of variables are (conditionally) independent. The difference of log-likelihood estimates is therefore zero in expectation. Note that this excludes children and descendants, but as discussed before, the orientation parameters converge to the opposite direction setting those edge likelihoods to zero.

For the edges that do not fulfill the assumption of Equation 5, a guarantee that those will be always discovered may not be given as this creates potential local optima. Specifically, such may lead to predicting an incorrect parent set for the child node, including possible false positive edges. Nevertheless, such edges are still often found as the assumptions consider the “worst-case” scenario for the parameters γ and θ. Furthermore, in some aspects, edges may be overestimated during a first iteration, for example, predicting more false positives than false negatives, as conditionally independent variables can be observed as dependent when other edges are missing. The sparsity regularizer may remove those edges once the probabilities of the correct edges converge. Hence, it is usually sufficient if the assumptions hold when each edge is sampled with a chance of 0.25 (e.g., after initialization).

Examples where this assumption is invalid for any value of [symbol] ₛₚₐᵣₛₑ>0 include (noisy) exclusive OR (XOR)-gates with its two input variables being independent of each other and uniformly distributed. Knowing only one out of the two variables does not improve the log-likelihood estimate for the output. Hence, the worst-case parent set in Equation 4 would be the empty set. Yet, when the edge probabilities are non-zero, adjacency matrices may be sampled with both input variables being a parent with a non-zero probability, which makes the detection of the edges possible.

To summarize, a confidence metric for converging to the correct causal graph if for every edge Xᵢ→Xⱼ, the pair of variables is not conditionally independent in the interventional data of Xᵢ, and the minimal improvement on the log-likelihood estimate when conditioning on Xᵢ is larger than [symbol] ₛₚₐᵣₛₑ.

So far, it is assumed that all variables of the graph are observable and can be intervened on. However, this is not always the case and some variables might be latent. The effect of the latent variables on the causal graph discovery may depend on how the latent variables are connected with observable variables. For instance, latent variables that are only children of observable variables or a parent of a single variable may not affect the discovery, as their existence cannot be detected from observational and interventional data. However, a common issue in causal discovery is the existence of latent confounders, as they introduce dependencies between variables on observational data without an edge in the ground truth graph. In discovery methods, latent confounders can cause false positive predictions of edges such as between X₁ and X₂. However, latent confounders for two variables cause a unique pattern of learned parameters: when intervening on Xᵢ or Xⱼ, having an edge between the two variables is disadvantageous, as the intervened graph, Xᵢ and Xⱼ are independent. Meanwhile, for interventions on all other variables, an edge can be beneficial, as Xᵢ and Xⱼ may be correlated.

In some aspects, the example causal graph discovery process 500 may also detect latent confounders. The latent confounders may, for instance, be between two variables that do not have any direct edges between each other. Also, the confounder is not a child of any other observed variable. Furthermore, despite a possible latent confounder, the guarantees for all other edges besides between Xᵢ and Xⱼ still apply, as Equation 5 already includes the possibility of additional edges in such cases. As discussed, the causal graph discovery may be performed. After convergence, every pair of variables may be scored on how likely they share a latent confounder using a function that is maximized. As edges are disadvantageous when intervening on Xᵢ and Xⱼ but beneficial otherwise, the two gradients may be recorded separately. In other words, γᵢⱼ=γᵢⱼ^{(I)}+γᵢⱼ^{(O)} may be defined where γᵢⱼ^{(I)} is only updated with gradients from Equation 2 under interventions on Xᵢ, and γᵢⱼ^{(O)} on all others. With this separation, the following score function may be maximized for latent confounder (lc) between Xᵢ and Xⱼ:

$$lc ( {X}_{i} , {X}_{j} ) = σ ( {γ}_{ij}^{( O )} ) \cdot σ ( {γ}_{ji}^{( O )} ) \cdot ( 1 - σ ( {γ}_{ij}^{( I )} ) ) \cdot ( 1 - σ ( {γ}_{ji}^{( I )} ) ) \qquad ( 6 )$$

To influence and in some aspects, guarantee a convergence to the mentioned values, especially of γᵢⱼ^{(O)}, a similar condition is used, as in Equation 5: the improvement on the log-likelihood estimate gained by the edge Xᵢ→Xⱼ and conditioned on all other parents of Xⱼ, is larger than [symbol] ₛₚₐᵣₛₑ. The same condition holds in the opposite direction. For all other pairs of variables, the score function is zero if all parameters have fully converged. Thus, latent confounders may be detected by checking whether the score function lc(Xᵢ, Xⱼ) is greater than a threshold (e.g., τ∈(0.0, 1.0)).

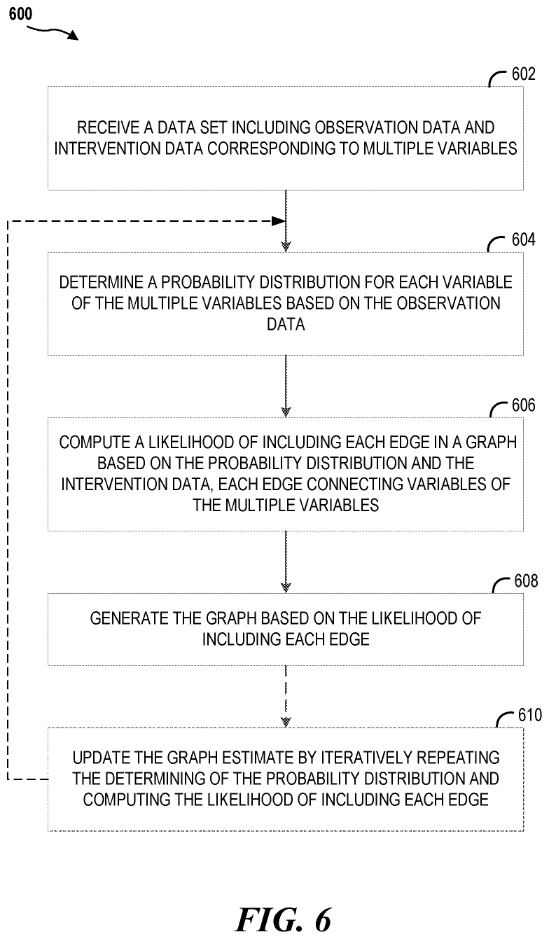

FIG. 6 is a flow diagram illustrating a method 600 for processing program code, in accordance with aspects of the present disclosure. As shown in FIG. 6, at block 602, a data set including observation data and intervention data corresponding to multiple variables is received.

At block 604, a probability distribution is determined for each variable of the multiple variables based on the observation data. In some aspects, the probability distribution is determined by dropping one or more variables as inputs. The dropping may be randomly performed, for example.

At block 606, a likelihood of including each edge in a graph is computed based on the probability distribution and the intervention data. Each edge connects variables of the multiple variables. As described with reference to FIG. 5, the likelihood of an edge between Xᵢ and Xⱼ is determined by p(Xᵢ→Xⱼ)=σ(γᵢⱼ)·σ(θᵢⱼ), where σ is the sigmoid function and θᵢⱼ=−θⱼᵢ (e.g., the probability of the two orientations may sum to one). The likelihood of each edge is computed based on an edge parameter and an orientation parameter. The edge parameter models the existence of an edge and the orientation parameter models a direction of the edge.

At block 608, the graph is generated based on the likelihood of including each edge. As described, after training, an initial version of the graph may be obtained by selecting the edges for which σ(γᵢⱼ) and σ(θᵢⱼ) is greater than 0.5. Thereby, the orientation parameters prevent any two-variable loops as in only one direction, σ(θᵢⱼ) can be greater than 0.5. The edges may be removed from the graph if the likelihood is below the threshold. In some aspects, the likelihood may be determined based on a sparsity parameter.

At block 610, the graph may optionally be updated by iteratively repeating

the determining the probability distribution (at block 604) and computing the likelihood of including each edge (at block 606). As described, the probabilities may be optimized such that all edges in the ground truth graph converge to one and with the correct direction, and all others to zero. Accordingly, the probabilities may be learned in an iterative manner.

Implementation examples are described in the following numbered clauses:
1. A method, comprising:
receiving a data set including observation data and intervention data corresponding to a plurality of variables;
determining a probability distribution for each variable of the plurality of variables based on the observation data;
computing a likelihood of including each edge in a graph based on the probability distribution and the intervention data, each edge connecting variables of the plurality of variables; and
generating the graph based on the likelihood of including each edge.
2. The method of clause 1, further comprising updating the graph by iteratively repeating the determining the probability distribution and computing the likelihood of including each edge.
3. The method of any of clauses 1-2, in which the probability distribution is determined by dropping one or more variables as inputs.
4. The method of any of clauses 1-3, in which the dropping is performed randomly.
5. The method of any of clauses 1-4, in which the likelihood of including each edge is determined based on a first parameter and a second parameter, the first parameter models existence of an edge and the second parameter models a direction of the edge.
6. The method of any of clauses 1-5, further comprising:
comparing the likelihood of including each edge to a predefined threshold; and
removing an edge from the graph based on the comparison.
7. The method of any of clauses 1-6, in which the second parameter controls the graph to be acyclic.
8 The method of any of clauses 1-7, in which the likelihood of including each edge is computed based on a sparsity regularizer.
9. The method of any of clauses 1-8, further comprising outputting a causal graph when the likelihood of including each edge in the graph converges to one.
10. An apparatus, comprising:
a memory; and
at least one processor coupled to the memory, the at least one processor being configured:
to receive a data set including observation data and intervention data corresponding to a plurality of variables;
to determine a probability distribution for each variable of the plurality of variables based on the observation data;
to compute a likelihood of including each edge in a graph based on the probability distribution and the intervention data, each edge connecting variables of the plurality of variables; and
to generate the graph based on the likelihood of including each edge.
11. The apparatus of clause 10, in which the at least one processor is further configured to update the graph by iteratively repeating the determining the probability distribution and computing the likelihood of including each edge.
12. The apparatus of any of clauses 10-11, in which the at least one processor is further configured to determine the probability distribution by dropping one or more variables as inputs.
13. The apparatus of any of clauses 10-12, in which the at least one processor is further configured to perform the dropping randomly.
14. The apparatus of any of clauses 10-13, in which the at least one processor is further configured to determine the likelihood of including each edge based on a first parameter and a second parameter, the first parameter models existence of an edge and the second parameter models a direction of the edge.
15. The apparatus of any of clauses 10-14, in which the at least one processor is further configured:
to compare the likelihood of each including edge to a predefined threshold; and
to remove an edge from the graph based on the comparison.
16. The apparatus of any of clauses 10-15, in which the second parameter controls the graph to be acyclic.
17. The apparatus of any of clauses 10-16 in which the at least one processor is further configured to compute the likelihood of including each edge based on a sparsity regularizer.
18. The apparatus of any of clauses 10-17, in which the at least one processor is further configured to output a causal graph when the likelihood of including each edge in the graph converges to one.
19. An apparatus, comprising:
means for receiving a data set including observation data and intervention data corresponding to a plurality of variables;
means for determining a probability distribution for each variable of the plurality of variables based on the observation data;
means for computing a likelihood of including each edge in a graph based on the probability distribution and the intervention data, each edge connecting variables of the plurality of variables; and
means for generating the graph based on the likelihood of including each edge.
20. The apparatus of clause 19, further comprising means for updating the graph by iteratively repeating the determining the probability distribution and computing the likelihood of including each edge.
21. The apparatus of any of clauses 19-20, further comprising means for determining the probability distribution by dropping one or more variables as inputs.
22. The apparatus of any of clauses 19-21, in which the dropping is performed randomly.
23. The apparatus of any of clauses 19-22, further comprising means for determining the likelihood of including each edge based on a first parameter and a second parameter, the first parameter models existence of an edge and the second parameter models a direction of the edge.
24. The apparatus of any of clauses 19-23, further comprising:
means for comparing the likelihood of including each edge to a predefined threshold; and
means for removing an edge from the graph based on the comparison.
25. The apparatus of any of clauses 19-24, in which the second parameter controls the graph to be acyclic.
26. The apparatus of any of clauses 19-25, further comprising means for computing the likelihood of including each edge based on a sparsity regularizer.
27. The apparatus of any of clauses 19-26, further comprising means for outputting a causal graph in response to the likelihood of including each edge in the graph converging to one.
28. A non-transitory computer readable medium having encoded thereon program code, the program code being executed by a processor and comprising:
program code to receive a data set including observation data and intervention data corresponding to a plurality of variables;
program code to determine a probability distribution for each variable of the plurality of variables based on the observation data;
program code to compute a likelihood of including each edge in a graph based on the probability distribution and the intervention data, each edge connecting variables of the plurality of variables; and
program code to generate the graph based on the likelihood of including each edge.
29. The non-transitory computer readable medium of clause 28, further comprising program code to update the graph by iteratively repeating the determining the probability distribution and computing the likelihood of including each edge.
30. The non-transitory computer readable medium of clause 28 or 29, further comprising program code to determine the probability distribution by dropping one or more variables as inputs.

In some aspects, the receiving means, determining means, computing means, generating means and/or updating means may be the GPU 104, program memory associated with the GPU 104, fully connected layers 362, NPU 428 and or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method, comprising:
receiving a data set including observation data and intervention data corresponding to a plurality of variables;
determining a probability distribution for each variable of the plurality of variables based on the observation data;
computing a likelihood of including each edge in a graph based on the probability distribution and the intervention data, each edge connecting variables of the plurality of variables; and
generating the graph based on the likelihood of including each edge.

2. The method of claim 1, further comprising updating the graph by iteratively repeating the determining the probability distribution and computing the likelihood of including each edge.

3. The method of claim 1, in which the probability distribution is determined by dropping one or more variables as inputs.

4. The method of claim 3, in which the dropping is performed randomly.

5. The method of claim 1, in which the likelihood of including each edge is determined based on a first parameter and a second parameter, the first parameter models existence of an edge and the second parameter models a direction of the edge.

6. The method of claim 5, further comprising:
comparing the likelihood of including each edge to a predefined threshold; and
removing an edge from the graph based on the comparison.

7. The method of claim 5, in which the second parameter controls the graph to be acyclic.

8. The method of claim 1, in which the likelihood of including each edge is computed based on a sparsity regularizer.

9. The method of claim 1, further comprising outputting a causal graph when the likelihood of including each edge in the graph converges to one.

10. An apparatus, comprising:
a memory; and
at least one processor coupled to the memory, the at least one processor being configured:
to receive a data set including observation data and intervention data corresponding to a plurality of variables;
to determine a probability distribution for each variable of the plurality of variables based on the observation data;
to compute a likelihood of including each edge in a graph based on the probability distribution and the intervention data, each edge connecting variables of the plurality of variables; and
to generate the graph based on the likelihood of including each edge.

11. The apparatus of claim 10, in which the at least one processor is further configured to update the graph by iteratively repeating the determining the probability distribution and computing the likelihood of including each edge.

12. The apparatus of claim 10, in which the at least one processor is further configured to determine the probability distribution by dropping one or more variables as inputs.

13. The apparatus of claim 12, in which the at least one processor is further configured to perform the dropping randomly.

14. The apparatus of claim 10, in which the at least one processor is further configured to determine the likelihood of including each edge based on a first parameter and a second parameter, the first parameter models existence of an edge and the second parameter models a direction of the edge.

15. The apparatus of claim 14, in which the at least one processor is further configured:
to compare the likelihood of each including edge to a predefined threshold; and
to remove an edge from the graph based on the comparison.

16. The apparatus of claim 14, in which the second parameter controls the graph to be acyclic.

17. The apparatus of claim 10, in which the at least one processor is further configured to compute the likelihood of including each edge based on a sparsity regularizer.

18. The apparatus of claim 10, in which the at least one processor is further configured to output a causal graph when the likelihood of including each edge in the graph converges to one.

19. An apparatus, comprising:
means for receiving a data set including observation data and intervention data corresponding to a plurality of variables;
means for determining a probability distribution for each variable of the plurality of variables based on the observation data;
means for computing a likelihood of including each edge in a graph based on the probability distribution and the intervention data, each edge connecting variables of the plurality of variables; and
means for generating the graph based on the likelihood of including each edge.

20. The apparatus of claim 19, further comprising means for updating the graph by iteratively repeating the determining the probability distribution and computing the likelihood of including each edge.

21. The apparatus of claim 19, further comprising means for determining the probability distribution by dropping one or more variables as inputs.

22. The apparatus of claim 21, in which the dropping is performed randomly.

23. The apparatus of claim 19, further comprising means for determining the likelihood of including each edge based on a first parameter and a second parameter, the first parameter models existence of an edge and the second parameter models a direction of the edge.

24. The apparatus of claim 23, further comprising:
means for comparing the likelihood of including each edge to a predefined threshold; and
means for removing an edge from the graph based on the comparison.

25. The apparatus of claim 23, in which the second parameter controls the graph to be acyclic.

26. The apparatus of claim 19, further comprising means for computing the likelihood of including each edge based on a sparsity regularizer.

27. The apparatus of claim 19, further comprising means for outputting a causal graph in response to the likelihood of including each edge in the graph converging to one.

28. A non-transitory computer readable medium having encoded thereon program code, the program code being executed by a processor and comprising:
program code to receive a data set including observation data and intervention data corresponding to a plurality of variables;
program code to determine a probability distribution for each variable of the plurality of variables based on the observation data;
program code to compute a likelihood of including each edge in a graph based on the probability distribution and the intervention data, each edge connecting variables of the plurality of variables; and
program code to generate the graph based on the likelihood of including each edge.

29. The non-transitory computer readable medium of claim 28, further comprising program code to update the graph by iteratively repeating the determining the probability distribution and computing the likelihood of including each edge.

30. The non-transitory computer readable medium of claim 28, further comprising program code to determine the probability distribution by dropping one or more variables as inputs.
